(19) United States
(12) Patent Application Publication
(10) Pub. No.: US 2004/0202834 A1
(43) Pub. Date: Oct. 14, 2004

(54) Thin-sheet resin-coated carrier

(75) Inventors: Ching-I Yu, Bade City (TW); Lang-Ching Chih, Taoyuan (TW); Kang-Tsun Liu, Miaoli (TW); Kung-Ming Yen, Pingjen City (TW)

Correspondence Address: BACON & THOMAS, PLLC, 625 SLATERS LANE, FOURTH FLOOR, ALEXANDRIA, VA, 22314

(73) Assignee: S & S Technology Corp., Taoyuan (TW)

(21) Appl. No.: 10/246,531

(22) Filed: Sep. 19, 2002

(51) Int. Cl. B32B 3/00

(52) U.S. Cl. 428/195.1

(57) ABSTRACT

A resin-coated carrier having a sheet-like base, the sheet-like base corresponding to the shape of a PC board substrate on a relatively smaller scale, and a resin of a predetermined thickness covered over one side of the sheet-like base for bonding to a PC board substrate for making a PC board without causing an overflow of the resin.

### BACKGROUND OF THE INVENTION

1. Field of the Invention

The present invention relates to a resin-coated carrier for making a printed circuit board and, more particularly to a thin-sheet resin-coated carrier.

2. Description of the Related Art

A regular resin-coated carrier 70 for making a printed circuit board, as shown in FIG. 1, is made of copper foil and covered with a layer of resin 75. When making a PC board, two resin-coated carriers 70 are respectively adhered to the top and bottom sides of a PC board substrate 80. As illustrated in FIG. 2, two planar tools (mirror plates) 79 are pressed on the resin-coated carriers 70 against the top and bottom sides of the PC board substrate 80 and heated, thereby causing the resin 75 of the resin-coated carriers 70 to be respectively bonded to the top and bottom sides of the PC board substrate 80. After bonding, the excessive part of the resin-coated carriers 70 is cut away, and then the PC board substrate with the bonded resin-coated carriers 70 are processed through an etching process to form the desired circuitry. This design of resin-coated carriers has drawbacks. When squeezing the mirror plates 79 against the resin-coated carriers 70 and the PC board substrate 80, a small amount of the melted resin flows out of the top and bottom sides of the PC board substrate 80, thereby causing the resin-coated carriers 70 to be peripherally bonded to each other around the PC board substrate 80. When the resin-coated carriers 70 peripherally bonded together, the follow cutting procedure becomes complicated. Furthermore, the overflow of resin may contaminate the mirror plates 79. The procedure of removing adhered resin from the mirror plates 79 may cause damage to the surface of the mirror plate 79. In order to facilitate removal of an overflow of resin, a release film (not shown) may be used and set between the resin-coated carrier 70 and the corresponding lens board 79 for absorbing the resin. The use of the release film greatly increases the PC board manufacturing cost.

### SUMMARY OF THE INVENTION

The present invention has been accomplished under the circumstances in view. It is the main object of the present invention to provide a resin-coated carrier, which does not cause the resin to flow out when bonded to the PC board substrate. It is another object of the present invention to provide a resin-coated carrier, which does not contaminate the mirror plates when bonding to the PC board substrate. It is still another object of the present invention to provide a resin-coated carrier, which eliminates the use of a release film when bonding to the PC board substrate. To achieve these and other objects of the present invention, the resin-coated carrier comprises a sheet-like base, a sheet-like base, having one bonding area in one side thereof, said bonding area of said sheet-like base corresponding to the shape of said PC board substrate on a relatively smaller scale, and a resin of a predetermined thickness covered over said bonding area for bonding to a respective PC board substrate for making a PC board. According to the embodiment of the present invention, the sheet-like base is made subject to the shape of the PC board substrate on a relatively smaller scale, having only one bonding area covered with the resin. According to the second embodiment, the base is a roll of sheet material having longitudinally equally spaced bonding areas respectively covered with the resin. Each bonding area has the shape of the PC board substrate on a relatively smaller scale.

### BRIEF DESCRIPTION OF THE DRAWINGS

FIG. 1 is a schematic drawing showing the arrangement of two resin-coated carriers at two sides of a PC board substrate according to the prior art.

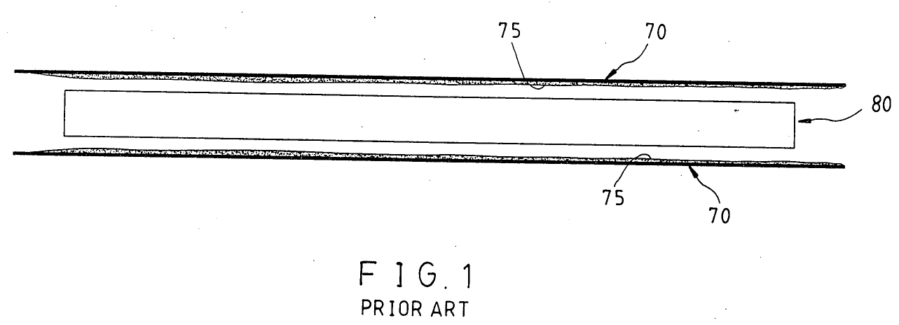

FIG. 2 is a schematic drawing showing two resin-coated carriers bonded to top and bottom sides of a PB board substrate and resin flowed out of the PB board substrate according to the prior art.

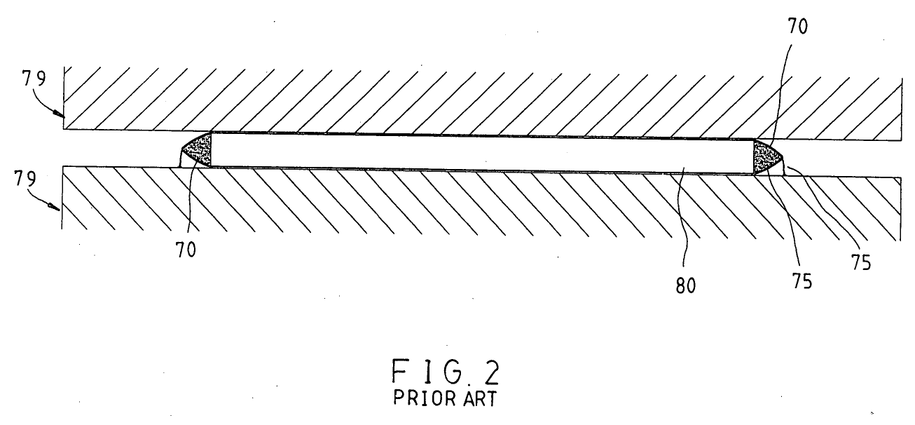

FIG. 3 is a perspective view of a resin-coated carrier constructed according to the first embodiment of the present invention.

FIG. 4 is a schematic drawing showing two resin-coated carriers squeezed between two lens boards and bonded to top and bottom sides of a PC board substrate according to the present invention.

FIG. 5 is a perspective view of a resin-coated carrier constructed according to the second embodiment of the present invention.

### DETAILED DESCRIPTION OF THE PREFERRED EMBODIMENT

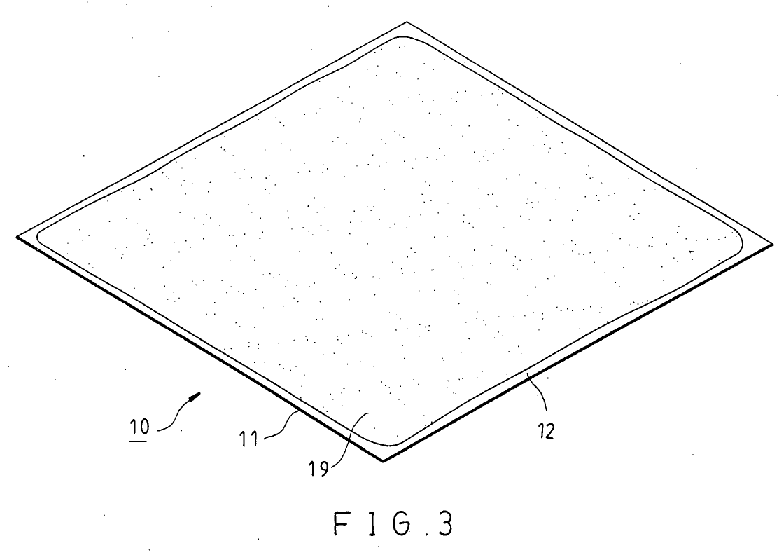

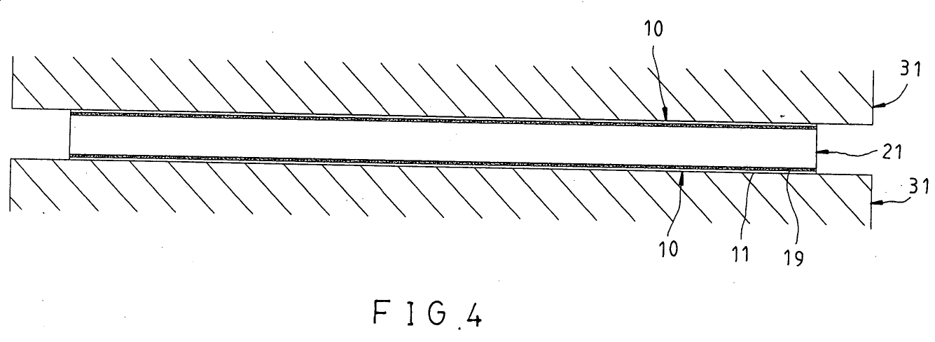

Referring to FIGS. 3 and 4, a resin-coated carrier 10 is adapted for adhering to a PC board substrate 21, which is made of electrically insulating material. The resin-coated carrier 10 is a resin coated copper foil comprising a sheet-like base 11 corresponding to the shape of the PC board substrate 21, a resin 19 uniformly covered over one side, namely, the bonding side 12 of the sheet-like base 11 subject to a predetermined thickness. When the sheet-like base 11 adhered to the PC board substrate 21, the PC board substrate 21 covers the area of the resin 19.

Referring to FIG. 4 again, two resin-coated carriers 10 are respectively attached to the top and bottom sides of the PC board substrate 21, and then two mirror plates 31 are respectively pressed on the copper foils of the resin-coated carriers 10 when heating, causing the resin 19 of each resin-coated carrier 10 to be respectively bonded to the top and bottom sides of the PC board substrate 21. Because the resin-coated carriers 10 have the shape of the PC board substrate 21 on a relatively smaller scale and the resin 19 of each resin-coated carrier 10 does not cover the whole area of the corresponding side (the top side or bottom side) of the PC board substrate 21, the resin 19 of each resin-coated carrier 10 does not flow out of the PC board substrate 21 when squeezing the mirror plates 31 against the resin coated carriers 10 and the PC board substrate 21 to force the resin 19 of each resin-coated carrier 10 to spread outwards, i.e., the resin-coated carrier 10 eliminates the resin overflow problem when adhering to the PC board substrate as encountered in the prior art designs.

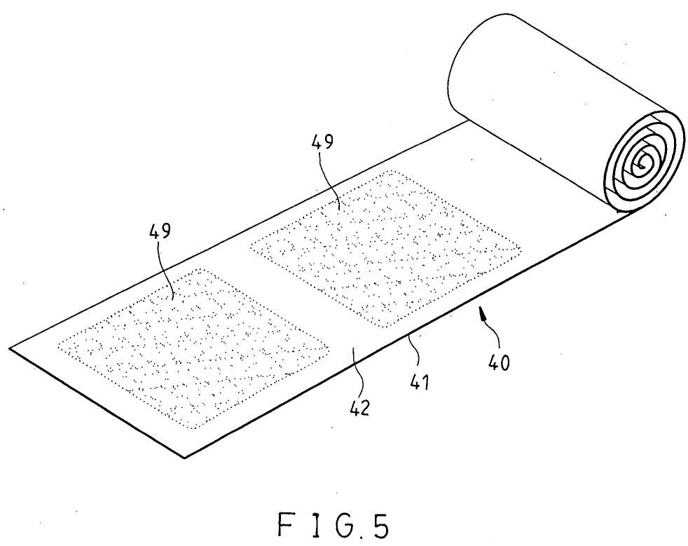

FIG. 5 shows an alternate form of the present invention. The resin-coated carrier 40 comprises a long, narrow sheet of base 41 and a resin 49 covered on one side, namely, the bonding side 42 of the base 41 at equally longitudinally spaced areas. Each resin 49 coated area of the bonding side 42 has the shape of the PC board substrate (not shown) on a relatively smaller scale. Because the resin 49 is not sticky, the resin-coated carrier 40 can be rolled up into a roll. The resin-coated carrier 40 is cut into units before use. The use of the cut units is same as the embodiment shown in FIGS. 3 and 4.

In the aforesaid two embodiments, the base 11 or 41 is made of copper foil. Alternatively, the base 11 or 41 can be made of polyethylene terephthalate film or any of a variety of sheet materials suitable for making printed circuit boards.

As indicated above, the resin 19 does not flow out of the PC board substrate 21 during lens board pressing and heating procedure, preventing bonding of the copper foils of the resin-coated carriers or contamination to the mirror plates 31. besides, the present invention doesn't need the application of release film. In general, the invention eliminates the drawbacks of the prior art designs.

Although particular embodiments of the invention have been described in detail for purposes of illustration, various modifications and enhancements may be made without departing from the spirit and scope of the invention. Accordingly, the invention is not to be limited except as by the appended claims.

1. A resin-coated carrier for being disposed on a PC board substrate, said carrier comprising: a sheet-like base [[,]] having one bonding area in one side thereof, said bonding area of said sheet-like base corresponding to the shape of said PC board substrate but with a smaller periphery, and a resin of a predetermined thickness covered over said bonding area for bonding to a respective PC board substrate without overflow of said resin from the periphery of said substrate, for making a PC board.

2. The resin-coated carrier as claimed in claim 1, wherein said sheet-like base is in the shape of rectangle.

3. The resin-coated carrier as claimed in claim 1, wherein said sheet-like base is a roll of sheet material having a plurality of longitudinally equally spaced bonding areas in one side.

4. The resin-coated carrier as claimed in claim 1, wherein said sheet-like base is made of copper foil or polyethylene terephthalate film.

5. The resin-coated carrier as claimed in claim 2, wherein said sheet-like base is made of copper foil or polyethylene terephthalate film.

6. The resin-coated carrier as claimed in claim 3, wherein said sheet-like base is made of copper foil or polyethylene terephthalate film.

7. The resin-coated carrier as claimed in claim 4, wherein said sheet-like base is made of copper foil.

8. The resin-coated carrier as claimed in claim 5, wherein said sheet-like base is made of copper foil.

9. The resin-coated carrier as claimed in claim 6, wherein said sheet-like base is made of copper foil.
